(19) United States
(12) Patent Application Publication
(10) Pub. No.: US 2019/0119956 A1
(43) Pub. Date: Apr. 25, 2019

(54) ANTI-THEFT PROTECTION FOR ARTICLES OF EQUIPMENT

(71) Applicant: Jay ALLEN, Bobcaygeon (CA)

(72) Inventor: Jay ALLEN, Bobcaygeon (CN)

(21) Appl. No.: 16/098,601

(22) PCT Filed: Apr. 28, 2017
(86) PCT No.: PCT/CA2017/050522

§ 371 Date: Nov. 2, 2018

Related U.S. Application Data
(60) Provisional application No. 62/331,289, filed on May 3, 2016.

(51) Int. Cl. E05B 73/00; A63B 60/56; A45C 13/30; A45C 13/40

(52) U.S. Cl. CPC E05B 73/0005; A63B 60/56; A63B 2102/24; A45C 13/40; A63B 2225/72; A45C 13/30

(57) ABSTRACT

Disclosed is an anti-theft device for at least one article of equipment, comprising: a body having at least one article-receiving passage that is open along a first article-receiving axis thereof, the at least one article-receiving passage configured in a first article-receiving mode to receive a structural segment of the article of equipment such that a second axis of the article of equipment will align with the first article-receiving axis, and configured in a second article-gripping and/or holding mode to grip and/or hold the structural segment of the article of equipment so as to minimize movement of the article of equipment relative to the passage, the body being configured to be maintained in the second mode to encumber the article.

### REFERENCE TO CO-PENDING APPLICATION

This application claims priority to U.S. Provisional Application No. 62/331,289, filed May 3, 2016. The entire subject matter of U.S. Provisional Application No. 62/331,289, filed May 3, 2016 is incorporated herein by reference.

### FIELD OF THE DISCLOSURE

The present disclosure relates to anti-theft devices for articles of equipment, such as, but not limited to, sports equipment.

### BACKGROUND

Sports tend to be expensive activities. This is especially evident in children's sports, such as hockey. A single hockey stick can cost in excess of $300. Hockey sticks tend to look the same from one player to the next. Hockey sticks are thus easy targets for theft.

### SUMMARY

Some aspects of this disclosure may provide methods and devices that overcome some of the drawbacks of known anti-theft techniques, or at least, provide the public with a useful alternative.

In one aspect, there is provided an exemplary anti-theft device for at least one article of equipment, the anti-theft device comprising a body having at least one article receiving passage that is open along a first article-receiving axis thereof, wherein the passage is configured in a first article-receiving mode to receive a structural segment of the article with a second axis thereof aligning with the first axis, and in a second article-gripping and/or holding mode to grip and/or hold the structural segment of the article so as to minimize movement of the article relative to the article receiving passage, the body being configured to be maintained in the second mode to encumber the article.

Some exemplary embodiments may further comprise at least one gripping portion that is positionable in the article receiving passage to define at last one gripping surface portion to grip the structural segment of the article.

In some exemplary embodiments, the at least one gripping portion may include a replaceable insert to occupy the passage and present a plurality of the gripping surface portions.

In another aspect, there is provided an insert, or a collection of inserts as defined herein, wherein the collection may be configured for different articles.

In another aspect, there is provided a method of deterring theft of an article of equipment, comprising providing a passage on an encumberable body, with the passage having a first axis, engaging the article of equipment with the passage in a manner to align a second axis of the article with the first axis and in a manner to inhibit movement of the article therein, and applying a lockable barrier to the passage to prevent removal of the article therefrom.

In some exemplary embodiments, the article is an article of sports equipment. In such a case, a related method of deterring the theft of the article of sports equipment may further comprise encumbering the body against theft by removably securing the body to an encumbering object near a site relevant to a game of the sport.

In another aspect, there is provided an anti-theft device for at least one article of sports equipment, comprising a body having at least a pair of boundaries forming at least one article-receiving passage therebetween, and which is open along a first article-receiving axis thereof, wherein the passage is configured in a first article receiving mode to receive a structural segment of the article with a second axis thereof aligning with the first axis, and in a second article-gripping mode to bias at least one of the boundaries toward the article-receiving passage to cause the structural segment of the article to be gripped and/or held in the passage in a manner that minimizes movement of the article relative to the passage, and wherein the body is configured to encumber the article when in the second mode.

Some exemplary embodiments, may further comprise an encumbering harness to secure the anti-theft device to an encumbering object.

In some exemplary embodiments, the body may be integrally formed with an encumbering object, wherein the encumbering object may be an equipment container, such as a sports equipment bag.

Some exemplary embodiments herein may be configured to be suited to articles of sports equipment, which may include hockey sticks, lacrosse sticks, curling brooms, baseball bats and any other sports apparatus or device with a shaft or handle, or other structural segments capable of being gripped or held in the passage.

In another aspect, there is provided a locking device comprising a body with an opening, the body being operable in a first mode to receive an article in the opening to be locked therein, a tether with a first anchoring structure for anchoring the tether at a first location on the body to form first and second tether portions that are configured to engage a lock, the lock being operable in a second mode to form a barrier across the opening to prevent removal of the article from the opening, at least one of the tethers including a second anchor structure for removable anchoring to a second location on the body in order to encumber the body on an encumbering object circumscribed at least in part by the second tether portion between the first and second anchoring structure, wherein the lock is configured to establish and maintain a tension on the first and second tether portions between the first and second anchoring structures, and wherein the tension enhances the barrier.

Any one or more elements or features of any embodiment, aspect or example in the disclosure, figures or claims herein may be combined with other elements or features of any embodiment, aspect or example in the disclosure, figures or claims herein, thereby to support one or more claims herein covering such combinations.

### BRIEF DESCRIPTION OF THE DRAWINGS

Several embodiments of the present disclosure are provided below, by way of examples only, with reference to the appended drawings, wherein:

FIGS. 1 to 9 are perspective views of an exemplary anti-theft device for sports equipment articles; and

FIGS. 10 to 15 are perspective views of portions of another exemplary anti-theft device for sports equipment articles.

### DETAILED DESCRIPTION OF EXEMPLARY EMBODIMENTS

It should be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Furthermore, and as described in subsequent paragraphs, the specific mechanical and/or other configurations illustrated in the drawings are intended to exemplify embodiments of the invention. However, other alternative mechanical and/or or other configurations are possible which are considered to be within the teachings of the instant disclosure.

The term “encumber” is intended to mean to restrict or to burden in such a way that free action or movement is difficult. In the context of at least some of the exemplary embodiments of anti-theft devices to be discussed below, the function of an anti-theft device may be met by securing the device to an immovable object, such as a wall support, a pillar, or some object either secured to the ground or essentially immovable because of its weight. On the other hand, an anti-theft device may be configured as a deterrent to a “grab and go” type of theft, as may be provided when the device is mounted to an object that, though portable, isn't easily portable, which in the case of a theft would mean not easy to lift, hide and to run or slip away from a theft scene unannounced. Thus, for example, a hockey stick may be encumbered when an anti-theft device is connected to a hockey bag or another designated encumbering object, such as a load supporting pole in a hockey change room, or the like. In this sense, a hockey bag may be perceived by a potential thief as being not easily carried in the context of the grab and go theft profiled above.

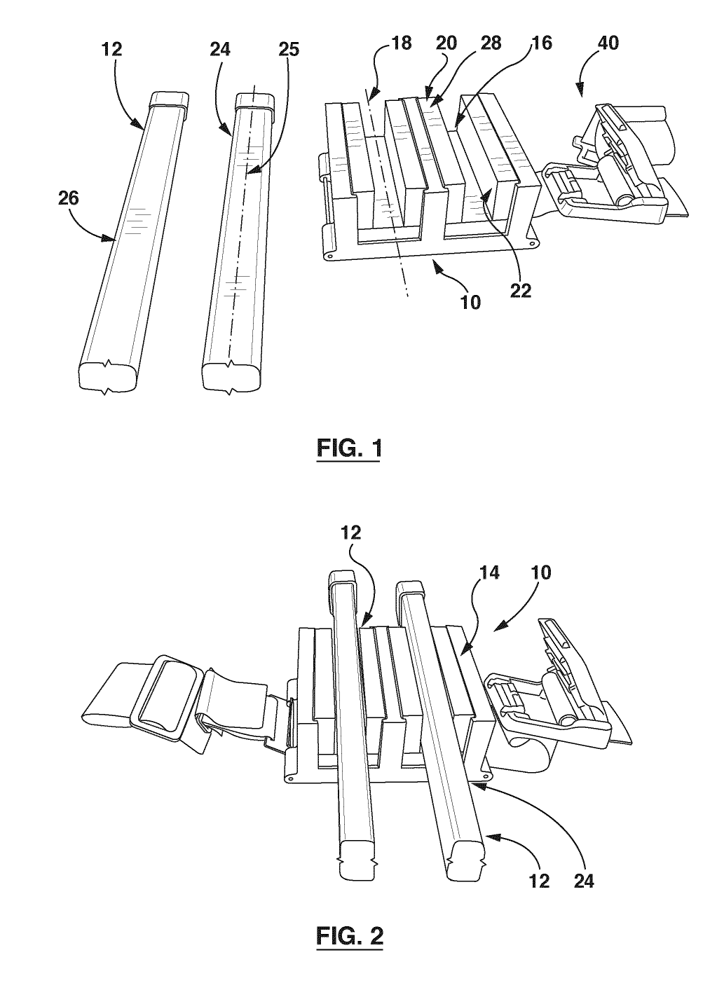

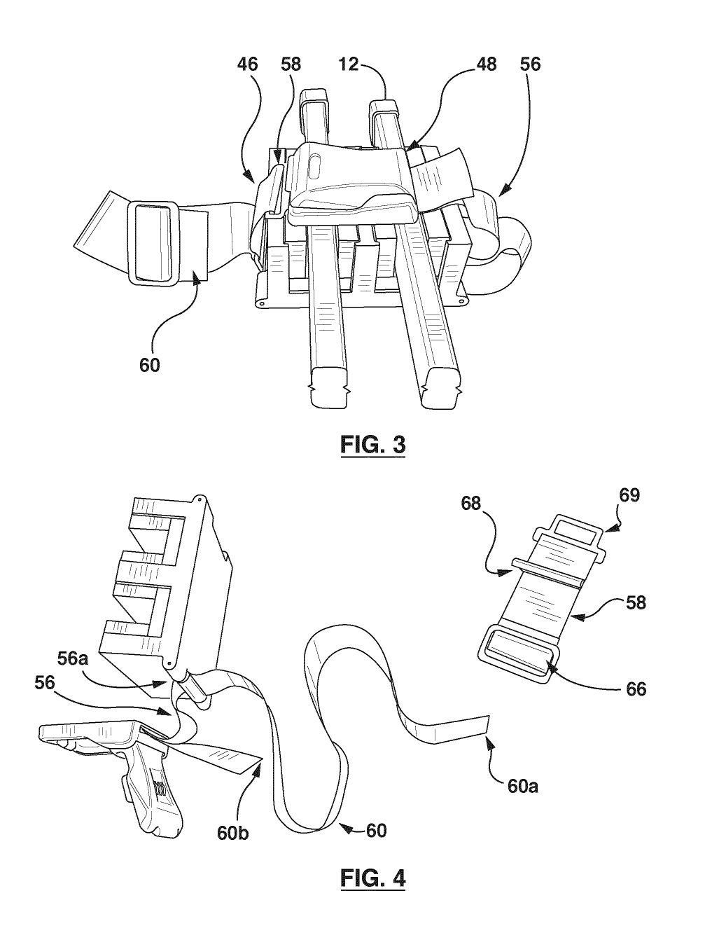

Referring to the figures, particularly FIGS. 1 and 2, an exemplary embodiment of an anti-theft device is shown at 10, for at least one article of sports equipment, in this case two such articles in the form of hockey sticks 12. The device 10 comprises a body 14 with one or more (in this case two) article receiving passages 16 which are open along a first article-receiving axis 18 thereof. Each passage 16 is configured in a first article-receiving mode, as shown in FIG. 1, to receive a structural segment 24 of the article with a second axis 25 thereof aligning with the first axis 18, and in a second article gripping mode, as shown in FIG. 3, to grip or to hold the structural segments so as to minimize movement of the sticks 12 relative to the passage 16. As will be described, the body 14 is configured to be maintained in the second mode to encumber the sticks 12.

The device 10 further comprises at least one gripping portion 20 (FIG. 1) positionable in the passage 16 to define at last one gripping surface portion 22 to grip the structural segment 24 of the hockey stick 12, in this case the shaft region 26. The at least one gripping portion may be provided, as in the case of device 10, as a replaceable insert 28 to occupy the passage 16 and present a plurality of the gripping surface portions 22.

The replaceable insert 28 may be configured according to a designated article, which in this case is the hockey stick 12. In this exemplary embodiment, the insert is further configured to engage, in particular, the shaft region 26 of the hockey stick 12.

The insert 28 may be selected from one of a number of inserts, as shown in FIG. 14, where each may be configured, and is shaped and/or sized according to a corresponding designated article to maximize the effectiveness of a gripping action or grip.

As can be seen with respect to the device 10 of FIGS. 10 to 14, to retain the insert 28 in the passage, the insert 28 may be provided with a plurality of first locating formations 30 (FIG. 13) to locate the insert 28 in the passage 16, and to engage complementary second locating formations, as shown at 32 (FIG. 12). In this case, the first locating formations 30 are ridges and the second location formations 32 are complementary grooves or openings, though other configurations may also be employed in other embodiments.

Referring again to FIG. 1, also provided on the device 10 is a barrier member, shown generally at 40, which is deployable across the passages 16 to block removal of articles contained in the passages 16. Exemplary barrier member embodiments are be described in more detail below.

As shown in the device of FIG. 10, the body 14 has a pair of boundary walls 42 on opposite sides of the passages 16, and the barrier 40 is configured to bias at least one of the boundary walls 42 toward the first axis 18, as represented by arrows B. Located between the boundary walls 42 is a central wall 44. In this case, the boundary walls 42 and central wall 44 are substantially parallel with the first axis 18. Alternatively, there may be some exemplary embodiments where the boundary walls need not be substantially parallel the first axis 18, such as in the case for gripping or holding a structural segment of an article that has nonparallel opposite contact surface portions, such as might occur on a baseball bat for instance.

Referring now to FIG. 3, the barrier member 40 further comprises at least one, and in this case a pair, of strap portions 56, 58, which extend laterally across the passages 16 when the barrier member is associated with the body 14, and a locking device 48 that is configured to lock the strap portions 56, 58 to maintain the body 14 in the second mode, as will be described in more detail below.

Referring to FIG. 10, each of the boundary walls 42 includes a periphery 42a, which define an opening to passages 16. At least one, and in this case both of the boundary walls 42, include a lateral flange 50 extending away from the corresponding passage 16 adjacent the periphery 42a, for engaging the strap portions (with one of the strap portions being shown schematically at 56).

The passages 16 are each defined by end flanges 52 in each end region, and which extend inwardly from opposed inner passage surfaces. Further, the end flanges 52 at each end region may be configured to engage corresponding outer end regions of the insert 28.

In some exemplary embodiments, such as the example of device 10 in FIGS. 3 and 4, the strap portions 56, 58 are joined at remote end regions by the locking device 48 in the second mode. Further, the strap portions 56, 58 in this case, extend from opposite ends of an encumbering strap 60, which is used to position the device on an encumbering object to deter theft, as will be described.

At least one mounting portion may be provided for mounting the encumbering strap 60 to the body 14. In the case of exemplary device 10, the at least one mounting portion may include a pair of mounting pins 62 (FIGS. 10, 12), each of which are held in opposed mounting sections 64 and may extend substantially parallel with the first axis.

Referring to FIG. 4, the exemplary strap portion 58 includes a buckle 66 stitched in at one end to engage a free end 60a of the encumbering strap 60. Even though the free end 60a is shown loose in FIG. 4, it is, in use, woven through the buckle 66 and then provided with a stitched-in stop to prevent removal therefrom, while being adjustable therein. A clip portion 68, positioned mid-way along the strap portion 58, is configured to clip to a corresponding mounting pin 62. A clasp 69 is located on the opposite end of strap 58 to engage the jaws of the locking device 48.

As shown in FIG. 4, the strap portion 56 is integrally formed on an end of the encumbering strap opposite the free end 60a and includes an anchoring passage 56a to receive a mounting pin 62 which, when secured by the mounting sections, anchors the encumbering strap 60 to the body 14. The anchoring passage 56a may be formed in this case by forming a loop, held by a lateral stitch in the strap portion 56. Thus, the free end of the strap portion is the opposite free end 60b of the encumbering strap 60, which is fed through the locking device 48 and then provided with a stitched-in stop to prevent the free end 60b from being removed from the locking device 48.

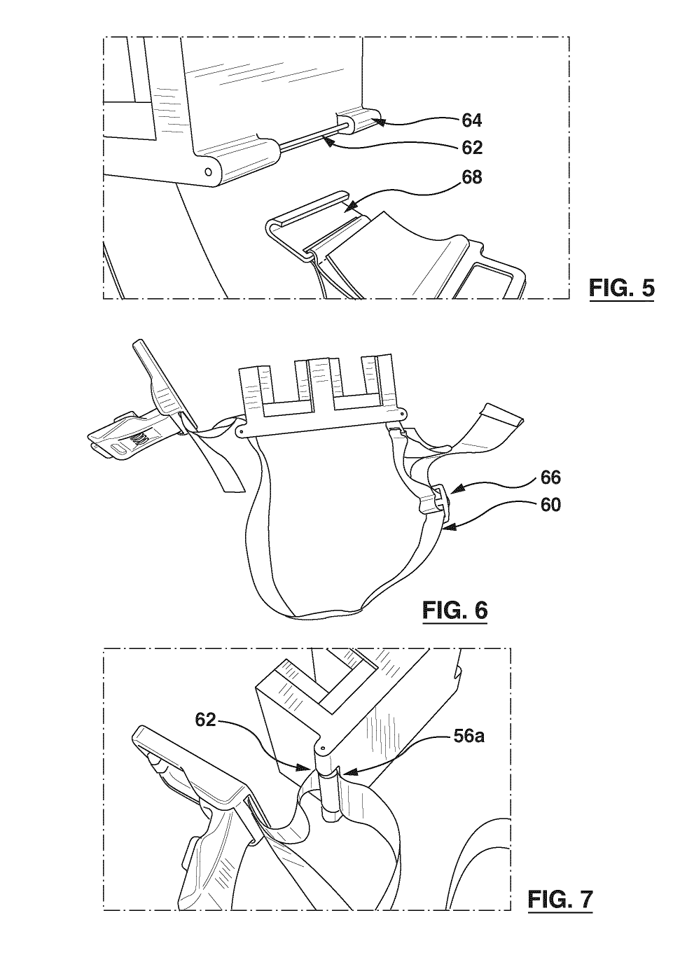

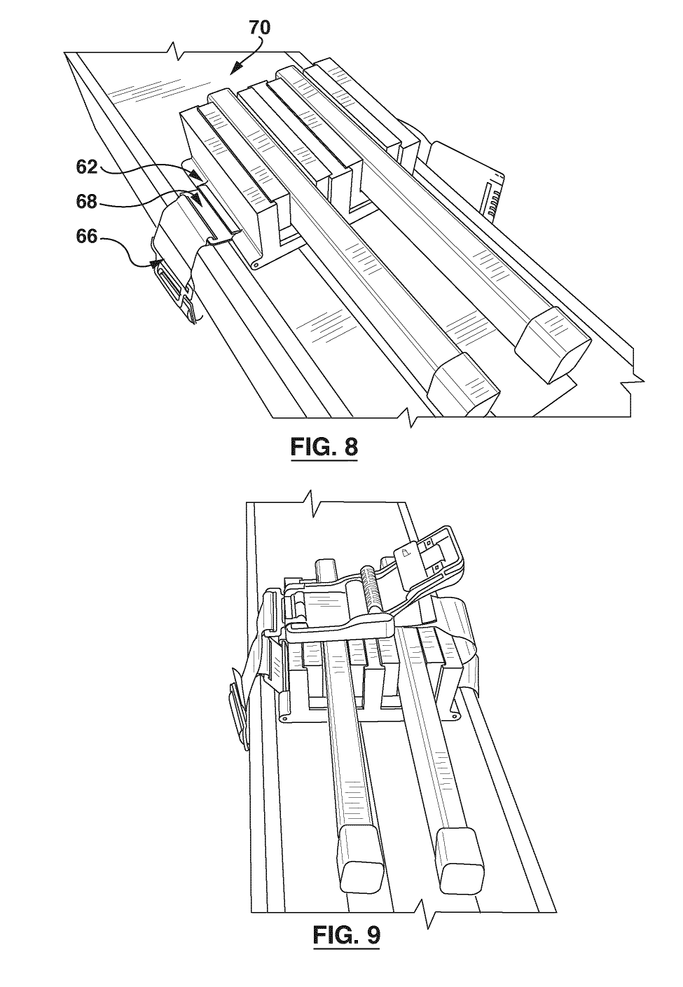

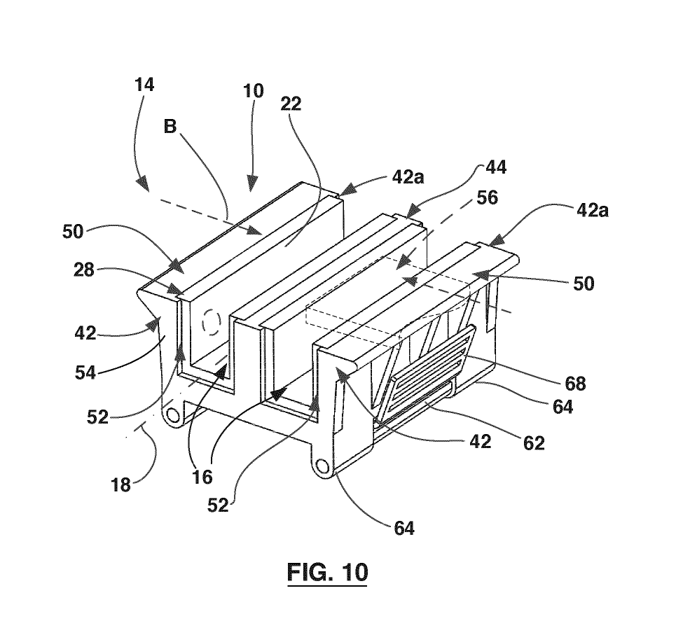

Referring to FIGS. 3 to 8, the anti-theft device 10 may be prepared for use by wrapping the encumbering strap 60 around an encumbering object, as represented by box 70 in FIG. 8. The clip portion 68 is then clipped to the corresponding mounting pin 62 and the encumbering strap 60 is tightened around the encumbering object by drawing the free end 60a through the buckle 66, thereby establishing tension in the encumbering strap 60 between the anchoring passage 56a at the corresponding mounting pin 62 on one side, and the clip portion 68 on the corresponding mounting pin 62 on the other side. The sticks 12 may then be inserted in the passages 16 and the straps 56 and 58 may then be engaged with the locking device 48 as shown in FIG. 3, that is by engaging the clasp 69 with the jaws of the locking device 48 and then cinching the strap 56 through the locking device 48, in a manner similar to that of a seat belt buckle in an aircraft, thus establishing tension in the strap portions 56, 58 between the anchoring passage 56a and the clip portion 68 at the corresponding mounting pins 62.

In some exemplary embodiments, the encumbering strap 60 in combination with the buckle 66, the strap portion 58, the clip portion 68 and the locking device may be prepared initially to be effectively loose to enable the encumbering strap 60 to be wrapped around any permanent, semi-permanent, or otherwise encumbering object, and then the clip portion 68 may be clipped around the corresponding mounting pin 62. Thus, with the sticks 12 in place, the locking of the locking device with the clasp 69 may operatively encase the passages with their contents, in this case sticks 12, to create a locked loop. The contents together with the device 10 are thus encumbered in place, if not secured, when a person cinches/pulls the end 60b of the strap portion 56 tight, so that the boundary walls 42, the inserts 28 and contents are compressed against each other as a result of the shortening of and thus tension in, the strap portions 56, 58 between, the mounting pins 62. Once the required tension/compression is achieved, the locking device may be closed to lock the strap so tensioned, thereby locking the sticks in position and the device 10 in its encumberment with the encumbering object, and held in this position by the locked locking device 48.

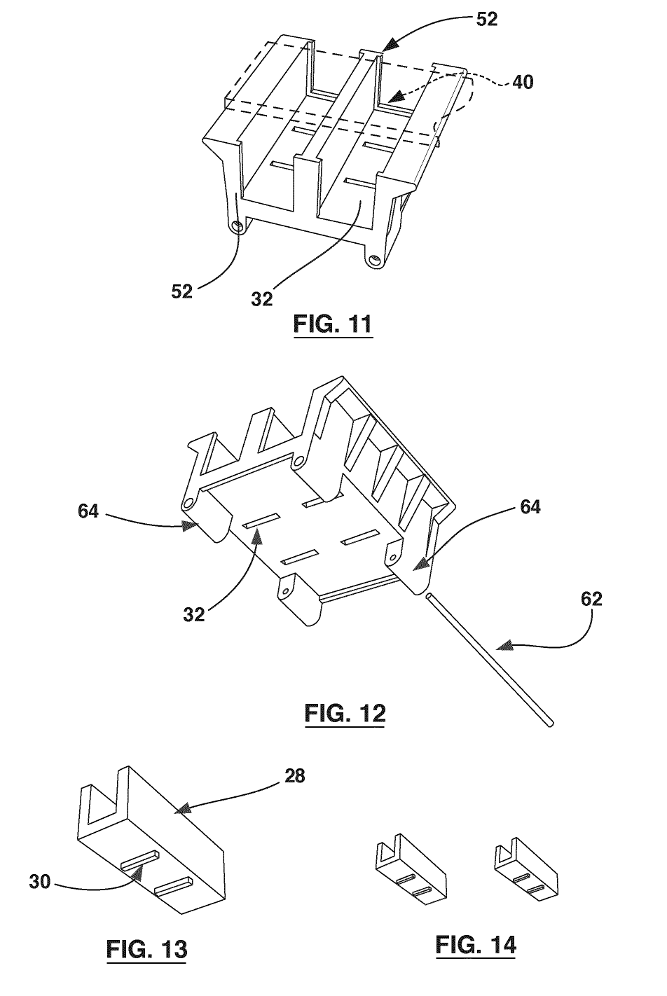

In some exemplary embodiments, the barrier member 40 may include strap portions as shown and discussed hereinabove, or may be in other forms, such as wire cables, wire reinforced cables, netting, chains, cabling, or the like. The barrier may also be provided by a member which is removably, or movably mounted on the body 14, such as adjacent the peripheries 42a and/or the lateral flanges 50, as shown schematically in FIG. 11.

In some exemplary embodiments, the insert or other gripping portion may be configured to provide the necessary grip to minimize, if not inhibit, movement of a hockey stick or other article in the passage, without necessarily the need for the barrier member to bias the boundary wall or walls as discussed above. In some exemplary embodiments, the gripping function action/capability may be configured into the body without necessarily needing the insert 28.

In some exemplary embodiments, the body may be configured to hold, without necessarily to grip, the article, thus providing a holding action in the second mode. For instance, the structural segment 24 may be keyed, that is provided with an exterior engagement forming shape or configuration, either in a male, female or other context, which would engage a complementary engagement forming shape, in a matching female, male or other complementary context, so as to form a positive engagement between the passage and the article to minimize, if not prevent, relative movement between the article and the passage.

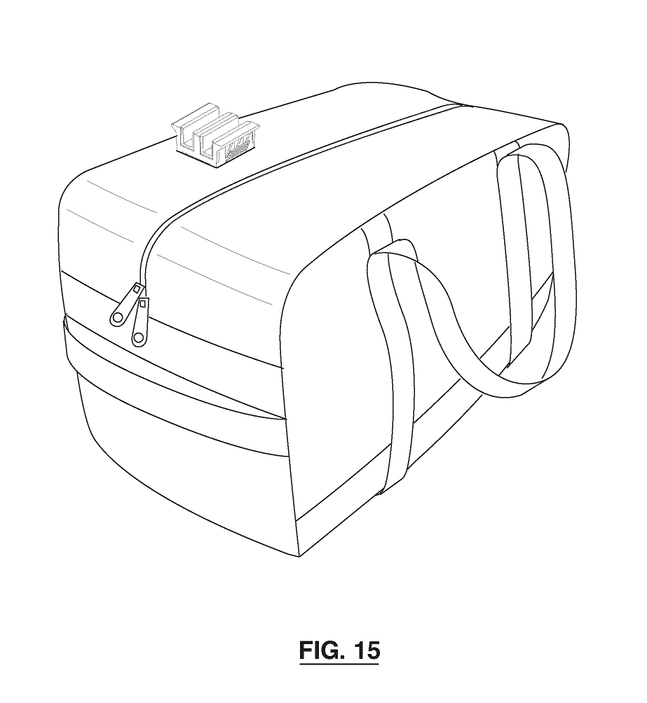

In some exemplary embodiments, the body 14 may be secured to an encumbering object in other ways without requiring the encumbering strap, such as by integrating the body into a hockey bag or the like, thus providing the passages to be exposed by being positioned on an outer surface of the hockey bag (as shown schematically in FIG. 15) or in an accessible inner location in the hockey bag (not shown).

In some exemplary embodiments, the gripping members may take the form of discrete pads or the like and may be located at operable locations in the passage, as schematically represented by the dashed ellipse in FIG. 10.

While the exemplary embodiments shown herein are focused on articles of sports equipment, the structure and function of exemplary embodiments may extend to other articles beyond articles of sport equipment. For example, other exemplary embodiments may be directed to any articles where there is an interest in providing approaches to reduce instances of theft for such articles.

Thus, some exemplary embodiments provide a purpose-built device for the security and anti-theft of personal sports equipment which may include, but is not limited to hockey sticks, lacrosse sticks, curling brooms, baseball bats, and any other sports apparatus or device with a shaft or handle. These types of equipment may be relatively expensive, relatively easily moved, removed, stolen and/or transported, and in some cases may look alike and thus may be mistakenly assumed or taken. Thus, some exemplary embodiments are aimed at deterring a “grab and go” removal or theft.

In some exemplary embodiments, the device may be made of several parts that, when used together, allows equipment to be protected to be locked into place between a purpose built rubber/foam insert which may be sized for the equipment being protected and which may compressed or squeezed between outside relatively more flexible walls of the mechanism main body and a relatively less flexible center wall, thereby allowing the outer walls to flex relative to the inner wall.

In some exemplary embodiments, the insert may be in the shape of a “U” channel, with a width and depth thereof that is configured according to, if not specific to, the equipment the device will be used to protect. The insert may also have a plurality (in the exemplary case shown, a pair) of ridges or grabs located on a bottom surface to help secure the insert into the cavity of the main body of the device.

In some exemplary embodiments, compression may be provided by way of a strap and combination buckle lock being connected from a fixed (or anchor) point of the body to a clip point which is located on an opposite side of the body. The joining of the two straps from their secure positions on the body (the anchor and clip points respectively) may compress outside tapered walls/lips or pins of the body, the inserts and the installed equipment. This compression, coupled with the lock may effectively wrap or close the open part of the body in a locked loop which may be utilized to provide several types of security to discourage, if not prevent and/or deter, a theft (such as a grab-and-go theft) of the contained equipment, which may include one or more of the following:
1. The compression on the equipment from the walls of the body being compressed may not allow the equipment to be easily slid or pulled out of the body;
2. The walls of the body and/or the equipment may be encased in (or wrapped with) a strap that has an associated and attached combination lock; and
3. The strap, the body and the contained equipment may be strapped around and locked to another object such as a sports bag, a pole, a stair rail or any other object to further secure or otherwise encumber the equipment.

In some exemplary embodiments, a buckle lock may be affixed to the end of the strap which may be affixed to the body at a point between two holders and an inserted pin. The fixed end of the strap may be sewn into a fixed position around the pin and become a fixed point. The other end of the strap (opposite to that of the buckle or the loose end has a sewn in clip or “J hook” that, when hooked around a similar pin on the opposite side of the body may create an anchor point. As the loose end of the strap (secured at the anchor point) is pulled through the buckle mechanism, the strap between these two points (the fixed point and the anchor point) may be tightened to compress the walls of the body, the insert and the equipment that it surrounds. When the body is closed or locked the strap may locked and the body may then remain locked in the compressed position and the strap from these two points may thus encase/wrap/strap over or close the opening of the body and the insert, and the equipment being held therein.

In some exemplary embodiments, although an insert and the equipment may be securely locked into the body through compression achieved from a lockable tight strap, there may be provided, in some cases, the ability to pick up the body and equipment contained therein. To secure the body, the insert and the equipment it protects to a permanent, or semi-permanent fixture, or another object, a user may wrap the loose end of the strap around the fixture or other object prior to affixing the hook to the anchor point, feeding the loose end of the strap through the buckle and locking the body, to secure the compressed and locked body and its contents to the fixture or other object to provide a theft deterrent.

In some exemplary embodiments, the inserts may be configured, including being built and/or sized to correspond with the size of some portion of the equipment to be protected. The inserts may be installed by a user based on the size of insert required, which is based on the size and type of equipment to be protected.

In some exemplary embodiments, the inserts may have complementary, if not the equivalent, external dimensions to so that they will fit within the cavity or receiver of the body, of which there may be one, two, three or four cavities, or as many cavities as may be designed/required. The inserts may be secured to the body with a plurality of formations, such as ridges or grabs, that will fit within complementary cavities in corresponding surfaces of the cavity.

In some exemplary embodiments, to further protect an insert from sliding out of a cavity, the body may be provided with built in lips, or lateral tab regions, at an end region of each cavity wall, so the insert tucks underneath or adjacent the lateral tab regions, to allow the insert to be kept in place, while not in use and to minimize movement of the insert relative to the body, as by sliding and the like, while under compression.

In some exemplary embodiments, the strap portion may be provided with a fixed and permanent or non-permanent anchor portion on one side, which may be sewn around a permanent pin on the device and one end fed through the locking device that has a sewn D ring in order to help pull the strap operatively tight, and thus compress the device, and also act as a stop to that the end of the strap that cannot be pulled back through the locking device. The loose end of the strap may be provided with a sewn in J hook, a sewn in slide buckle with a reducing strap and a D clip that mechanically attaches within the locking device. In this configuration, in order to tighten the slack in the strap, the excess strap may be pulled through the slide buckle to tighten the device and the object it protects to the permanent or non-permanent object. The end of the strap may be pulled through the slide buckle, and the D ring may be used to help pull the strap tight as well as act as a stop so that the loose end cannot be pulled through the slide buckle.

While the present disclosure describes various exemplary embodiments, the disclosure is not so limited. To the contrary, the disclosure is intended to cover various modifications and equivalent arrangements, as will be readily appreciated by the person of ordinary skill in the art.

1. An anti-theft device for at least one article of equipment, comprising: a body having at least one article-receiving passage that is open along a first article-receiving axis thereof, the at least one article-receiving passage configured in a first article-receiving mode to receive a structural segment of the article of equipment such that a second axis of the article of equipment will align with the first article-receiving axis, and configured in a second article-gripping and/or holding mode to grip and/or hold the structural segment of the article of equipment so as to minimize movement of the article of equipment relative to the passage, the body being configured to be maintained in the second mode to encumber the article.

2. The device of claim 1, further comprising a barrier member deployable across the at least one article-receiving passage to block removal of the article of equipment therefrom.

3. The device of any of claim 1 or 2, wherein the body has a pair of boundary walls on opposite sides of the article-receiving passage, and the barrier is configured to bias at least one of the boundary walls toward the first article-receiving axis.

4. The device of any of claims 1 to 3, wherein the boundary walls are substantially parallel with the first article-receiving axis.

5. The device of any of claims 1 to 4, wherein the barrier member further comprises at least one strap portion adapted to extend laterally across the at least one article-receiving passage, and a locking device for locking the strap portion to maintain the body in the second mode.

6. The device of any of claims 1 to 5, wherein each of the boundary walls includes a periphery defining a passage opening, at least one boundary wall including a lateral flange extending away from the at least one article-receiving passage adjacent the periphery for engaging the strap portion.

7. The device of any of claims 1 to 6, wherein each of the boundary walls includes an instance of the lateral flange extending away from each other.

8. The device of any of claims 1 to 7, wherein the at least one article-receiving passage is defined by at least one end flange in each end region thereof.

9. The device of any of claims 1 to 8, further comprising a pair of the end flanges at each end region, the end flanges extending inwardly from opposed inner passage surfaces.

10. The device of any of claims 1 to 9, further comprising a pair of said strap portions which, when the device is in the second mode, are joined by the locking device.

11. The device of any of claims 1 to 10, wherein the strap portions extend from opposite sections of an encumbering strap.

12. The device of any of claims 1 to 11, further comprising at least one mounting portion for mounting the encumbering strap to the body.

13. The device of any of claims 1 to 12, wherein the at least one mounting portion includes a pair of mounting pins, which extend substantially in parallel with the first axis.

14. The device of any of claims 1 to 13, further comprising a clip portion positioned on the encumbering strap and configured to removably couple with one of the mounting pins.

15. The device of any of claims 1 to 14, further comprising at least one gripping portion operable in the at least one article-receiving passage to define at last one gripping surface portion to grip the structural segment of the article of equipment.

16. The device of any of claims 1 to 15, wherein the at least one gripping portion includes a replaceable insert to occupy the at least one article-receiving passage and present a plurality of the gripping surface portions.

17. The device of any of claims 1 to 16, wherein the at least one article-receiving passage includes a pair of adjacent passages, with substantially parallel first longitudinal axes.

18. The device of any of claims 1 to 17, wherein the replaceable insert is configured according to a designated article.

19. The device of any of claims 1 to 18, wherein the insert is selected from one of a number of inserts, each configured according to a corresponding designated article.

20. The device of any of claims 1 to 19, wherein the insert includes a plurality of first locating formations to locate the insert in the at least one article-receiving passage, and to engage complementary second locating formations in the at least one article-receiving passage.

21. The device of any of claims 1 to 20, further comprising a pair of the end flanges at each end region of the passage, the end flanges extending inwardly from opposed inner passage surfaces and configured to engage corresponding outer end regions of the insert.

22. An insert according to any of claims 1 to 21.

23. A method of deterring theft of an article of equipment, comprising:
providing a passage on an encumberable body, the passage having a first axis;
engaging the article of equipment with the passage in a manner to align a second axis of the article with the first axis of the passage and in a manner to inhibit movement of the article therein; and
applying a lockable barrier to the passage to prevent removal of the article therefrom.

24. The method of claim 23, wherein the article is an article of sports equipment, and further comprising encumbering the body against theft by removably securing the body to an encumbering object near a site relevant to a game of the sport.

25. An anti-theft device for at least one article of sports equipment, comprising: a body having at least a pair of boundaries forming at least one article-receiving passage therebetween, the at least one article-receiving passage being open along a first article-receiving axis thereof and configured in a first article receiving mode to receive a structural segment of the article of sports equipment such that a second axis of the article of sports equipment will align with the first article-receiving axis, and configured in a second article-gripping mode to bias at least one of the boundaries toward the at least one article-receiving passage to cause the structural segment to be gripped and/or held in the at least one article-receiving passage in a manner that will minimize movement of the article of sports equipment relative to the at least one article-receiving passage, the body being configured to encumber the article of sports equipment when in the device is placed in the second mode.

26. The device of any claims 1 to 25, wherein the body includes one or more flexible and/or compressible portions that cooperate to flex and/or compress in the second mode.

27. The device of any of claims 1 to 26, further comprising a central wall and a pair of boundary walls on opposite sides of the central wall to define a pair of article-receiving passages, wherein the boundary walls are operable to be flexed toward the central wall in the second mode.

28. A device as defined in any of claims 1 to 27, further comprising an encumbering harness to secure the device to an encumbering object.

29. A device as defined in any claims 1 to 28, wherein the body is integrally formed with an encumbering object.

30. A device as defined in any of claims 1 to 29, wherein the encumbering object is an equipment container.

31. A locking device comprising:
a body with an opening and operable in a first mode to receive an article in the opening to be locked therein;
a tether with a first anchoring structure for anchoring the tether at a first location on the body to form first and second tether portions that are configured to engage a lock, the lock being operable in a second mode to form a barrier across the opening to prevent removal of the article from the opening; and
at least one of the tethers including a second anchor structure for removable anchoring to a second location on the body in order to encumber the body on an encumbering object circumscribed at least in part by the second tether portion between the first and second anchoring structure;
wherein the lock is configured to establish and maintain a tension on the first and second tether portions between the first and second anchoring structures, and wherein the tension enhances the barrier.

32. A device as shown or described in the disclosure, figures and/or claims herein.
